(19) United States
(12) Patent Application Publication
(10) Pub. No.: US 2016/0147864 A1
(43) Pub. Date: May 26, 2016

(54) METHOD AND SYSTEM FOR ONLINE COLLABORATION FOR DEVELOPING DIGITAL CONTENT

(71) Applicant: Jason Thomas Kane, Northville, MI (US)

(72) Inventor: Jason Thomas Kane, Northville, MI (US)

(21) Appl. No.: 14/950,842

(22) Filed: Nov. 24, 2015

Related U.S. Application Data
(60) Provisional application No. 62/083,743, filed on Nov. 24, 2014.

(51) Int. Cl. G06F 17/30; G06Q 30/06; G06Q 30/02

(52) U.S. Cl. CPC G06F 17/30598; G06F 17/3053; G06F 17/30867; G06Q 30/0206; G06Q 30/0613

(57) ABSTRACT

A computer network system implemented to facilitate online collaboration for developing a digital content. The system includes a database configured to provide means for storing and retrieving profiles of a plurality of digital artists, and categorizing the profiles based on skills of the digital artists to provide at least one predefined service relating to developing the digital content. The system also includes a web based platform configured to provide means for inputting one or more pieces of information about a concept of the digital content. The web based platform also provides means for selecting one or more digital artists from the plurality of digital artists for participation in the development of the digital content from the concept. The web based platform further provides means for storing the completed digital content, after development, in a data repository.

### TECHNICAL FIELD

The present disclosure generally relates to developing digital contents, and more specifically relates to a method and a system to facilitate online collaboration for developing and managing digital contents.

### BACKGROUND

The production of digital content, for example for a stock 3D model website, involves various development stages. In each of these development stages, different attributes of the digital 3D model are created, and reviewed. Generally, each of these development stages is completed by different digital artists with specialization in their respective role, and all of these roles are divided into various jobs within a studio production company, such as, for large video game and film companies, or the like, for efficiently creating digital content using specific skills of each design artist. Most basically, for 3D model development, these roles include an author, a concept artist, a model artist, a texture artist and a rigging artist.

Typically, the digital artists have training and experience in one particular area of digital 3D model production. An individual artist, generally, do not possess all the skills required to complete the 3D model or any other digital content on his/her own, for example the individual artist might not have the right approach compared to artists that specialize in other areas of 3D model development, or cannot competitively and efficiently create the 3D model alone. All design artists at some point need assistance from other designers who have specialization in other areas of 3D model creation.

Some online channels that offer a digital storefront to sell digital content, like stock 3D models, do not allow for artists to evaluate and seek out collaboration partners, set up collaboration projects with those partners, monitor the progress of the collaboration projects, negotiate personal price shares for collaboration projects, or sell them together online with a structured IP distribution. If a concept artist (or an author) has an idea for a digital content and wishes to build 3D models based on that idea; the artist, generally, have to approach some studios, such as brick and mortar 3D model production companies to hire services of other artists with complimentary skill sets. This can turn out to be very expensive affair for an individual artist. Some online medium exist for hiring services of digital artists with varying skills set, but these services are often broken and inefficient. For example, these online mediums do not allow the concept artist to provide feedback during intermediate stages of development of the content. Further the concept artist may have to pay the hired service provider immediately after completion of the provided service, without being sure if he/she will be able to sell their content after all and be able to recover the investment. Further, even if the concept artist manages to complete the development of his/her idea to create the corresponding 3D model, they, typically, do not have resources to put their digital assets for sale easily. Some online channels that offer a digital storefront to sell digital content, like stock 3D models, does not provide much control over the sale of the digital content.

Therefore there is a need of a system which can facilitate independent digital artists to collaborate and efficiently create high quality digital content without requiring any forefront investment.

### SUMMARY

In one aspect, the present disclosure provides a computer network system implemented to facilitate online collaboration for developing a digital content. The system includes a database configured to provide means for storing and retrieving profiles of a plurality of digital artists, and categorizing the profiles based on skills of the digital artists to provide at least one predefined service relating to developing the digital content. The system also includes a web based platform configured to provide means for inputting one or more pieces of information about a concept of the digital content. The web based platform also provides means for selecting one or more digital artists from the plurality of digital artists for participation in the development of the digital content from the concept. The web based platform further provides means for storing the completed digital content, after development, in a data repository.

In another aspect, the present disclosure provides a method implemented, over a computer network, to facilitate online collaboration for developing a digital content. The method includes creating, via the computer network, a database having profiles of a plurality of digital artists. The method also includes receiving, via the computer network, one or more pieces of information about a concept of the digital content. The method also includes selecting, via the computer network, one or more digital artists from the plurality of digital artists for participation in the development of the digital content from the concept. The method further includes storing, via the computer network, the completed digital content, after development, in a data repository.

The details of one or more implementations are set forth in the accompanying drawings and the description below. Other aspects, features and advantages of the subject matter disclosed herein will be apparent from the description, the drawings, and the claims.

### BRIEF DESCRIPTION OF THE DRAWINGS

FIG. 1 illustrates a schematic representation of a computer network system, in accordance with an embodiment of the present disclosure;

FIG. 2 illustrates a computer system for implementing a method of, in accordance with an embodiment of the present disclosure; and

FIG. 3 illustrates a flow chart illustrating a method for online collaboration for development of digital content, in accordance with an embodiment of the present disclosure.

### DETAILED DESCRIPTION

Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a basis for the claims and as a representative basis for teaching one skilled in the art to variously employ the present disclosure in any appropriate process for creating digital content.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the Internet.

The detailed description which follows is represented largely in terms of processes and symbolic representations of operations in a distributed computing environment by conventional computer components, including remote file servers, remote computer servers, remote memory storage devices, a processing unit, memory storage devices, display devices and input devices. Each of these conventional distributed computing components is accessible by the processing unit via a communications network.

The processes and operations performed by the computer include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text. Therefore, disclosure of a particular set of program code instructions is not considered necessary for an adequate understanding of how to make and use the invention. The inventive functionality of the claimed system will be explained in more detail in consideration of the following description read in conjunction with the appended figures.

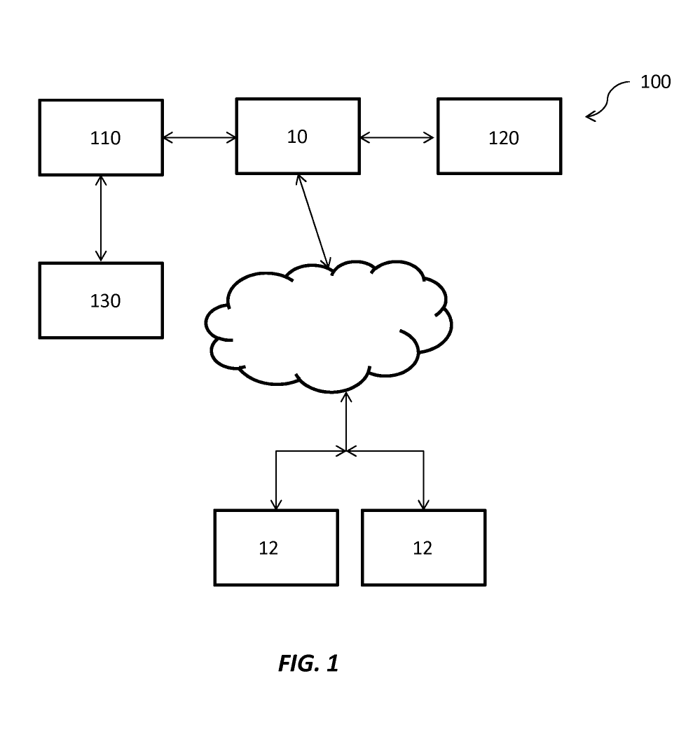

FIG. 1 illustrates a computer network system 100 according to some embodiments of the present invention. As shown in FIG. 1, an exemplary computer network system 100 for implementing processes according to embodiments of the present invention may include, but is not limited to, a general-purpose computing device 10 that interacts with users through a network, such as, but not limited to, the Internet. The computing device 10 may be a server 10 that communicates over a network with user devices 12, which include, but are not limited to, general-purpose computers, special-purpose computers, mainframes, gaming devices, tablet computers, smartphones, PDAs, audio editors, text readers, text editors, video players, video editors, image/graphic readers, image/graphic editors, a processor-based device, and the like. The user devices 12 may communicate with the server 10 through a web site or through another type of software interface. The user devices 12 may communicate with the server 10 through one or more applications including computer-executable instructions. Alternative embodiments may not involve a network at all, and may instead be implemented on a standalone device 10 used by the user(s). In some alternate embodiments, the user devices 12 communicate with each other in a peer-to-peer manner, without requiring the server 10.

The server 10 may be implemented as a network of computer processors. In some implementations, the server may be multiple servers, mainframe computers, networked computers, a processor-based device, or a similar type of system or device. In some implementations, the server 10 may be a server farm or data center. The server 10 may receive connections through a load-balancing server or servers. In some implementations, a task may be divided among multiple servers 10 that are working together cooperatively.

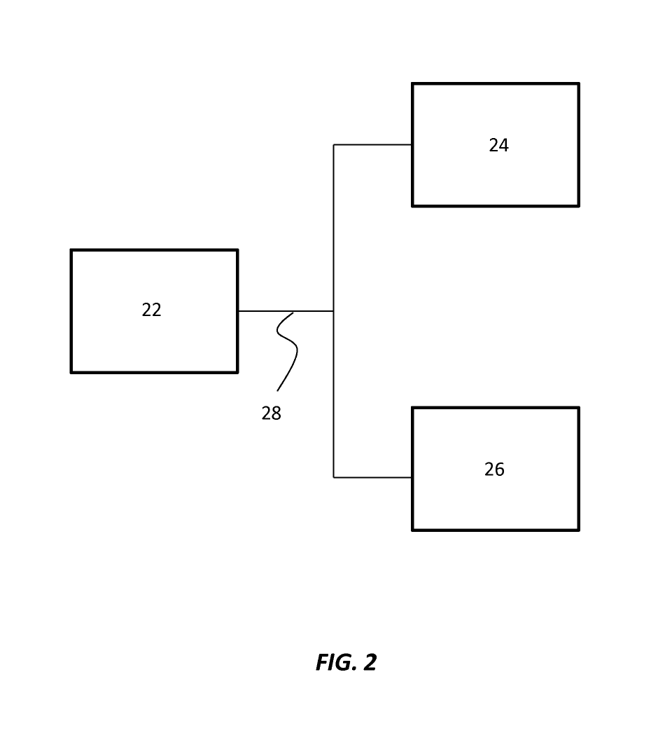

FIG. 2 illustrates a system according to some embodiments of the present invention. As shown in FIG. 2, an exemplary system for implementing the method(s) discussed includes (but is not limited to) a general-purpose computing device in the form of a conventional computer, including a processing unit 22 or processor, a system memory 26, and a system bus 28 that couples various system components including the system memory 26 to the processing unit 22. The system memory 26 may include one or more suitable memory devices such as, but not limited to, RAM. The computer may include a storage medium 24, such as, but not limited to, a solid state storage device and/or a magnetic hard disk drive (“HDD”) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. A storage medium 24 may be external to the computer, such as external drive(s), external server(s) including database(s), or the like. The drives and their associated computer-readable media may provide non-transient, non-volatile storage of computer-executable instructions, data structures, program modules, and other data for the computer to function in the manner described herein. Various embodiments employing software and/or Web implementations are accomplished with standard programming techniques.

Referring back to FIG. 1, the computer network system 100 makes use of several interoperating components. The computer network system 100 provides a database, schematically represented and indicated by numeral 110, and a web based platform, schematically represented and indicated by numeral 120, and an e-commerce platform 130. The database 110 (e.g., Cassandra (available from http://cassandra.apache.org), Hadoop (available from http://hadoop.apache.rg), MongoDB® (available from 10gen, Inc.) or MySQL™ (available from http://www.mysql.com)) is configured to handle data management, including user accounts, group state and statistics, lead history, among other data. The web based platform 120 and the e-commerce platform 130 may include any applicable web server such as, for example, Apache™ (available from http://httpd.apache.org), Node.js (available from http://nodejs.org/), Twisted (available from http://twistedmatrix.com), MongreL2™ (available from http://mongrel2.org), that supports a web application framework (e.g., Django® (available from Django Software Foundation) or Node.js™ (available from http://nodejs.org/)). The platforms 120, 130 provide services such as, for example, authentication, dynamic webpage generation, and an interface front end to the database 210. Django@ is a powerful WebApplication Framework, providing support for numerous backend databases, powerful authentication, dynamic webpage generation, and URL-address parsing. As Django is written in Python, a powerful scripting language, it is well suited for parsing and manipulating various forms of text-based data, such as HTML, XML and human-readable data, like chat messages.

In some embodiments, the database 110 can be stored as part of the platform 120 or can be a part of a stand-alone database server communicatively coupled to the server 10. Examples of database management system for controlling, maintaining and using the database 110 include MongoDB® and Cassandra. MongoDB® is a scalable, high-performance, open-source NoSQL database management system that provides powerful replication and high availability, allowing horizontal scaling without compromising functionality. In addition, NoSQL database management systems are suitable for databases requiring many writes and sequential reads. This is in contrast to relational databases, such as MySQL, which are good for relational queries, but perform poorly for frequent writes and sequential reads, especially for massive quantities of data. Such a database management system provides many features well-suited to enabling collaboration groups, including rich, document-based queries, flexible aggregation and data processing, and the ability to store files of any size without complicating the stack. Preferably, the database 110 is configured to handle large amounts of data spread across many commodity servers, providing a highly available service with no single point of failure.

Through the user devices 12, a digital artist registers with the platform 120, which in turn creates an account or profile for the digital artist and stores the profile in the database 110. Hereinafter the terms “user”, “digital artist” and “artist” have been interchangeably used for the purpose of the present disclosure. The user profile may include, for example, identification information and contact information associated with the digital artist and a record of the digital artist's contributions to the platform 120. The user profile may also include personal information supplied by the user, e.g., interests, hobbies, professional experience, etc. According to some embodiments, the database 110 is configured to provide means, such as storage devices, for storing and retrieving profiles of the plurality of digital artists. The database 110 is configured to provide means, such as processing devices, for categorizing the profiles based on skills of the digital artists to provide at least one predefined service relating to developing the digital content.

In one example, the profiles of the plurality of digital artists are categorized as, an author, a concept artist, a model artist, a texture artist and a rigging artist. That is, the platform 120 allows various users to create accounts to represent one of four disciplines: author, concept artist, modeler, and texture artist. The platform 120 provides means, such as a user interface, for inputting one or more pieces of information about a concept of the digital content. That is, the platform 120 allows the originator, typically authors and concept artists, to create a pool of text or drawn model concepts. In one example, the originator is one of the digital artists with profile being categorized as either of the author, the concept artist, the model artist or the texture artist. In another example, the originator is a team of two or more digital artists with profiles being categorized as either of the author, the concept artist, the model artist or the texture artist. In one embodiment, the digital content is a stock 3D model. The terms “digital content and “3D model” have been interchangeable used for the purpose of the present disclosure.

The platform 120 further provides means, such as a user interface, for selecting one or more digital artists from the plurality of digital artists for participation in the development of the digital content from the concept. The web based platform 120 is further configured to provide means, such as a user interface, for controlling selection of the one or more digital artists for participation in the development of the digital content. The web based platform 120 is further configured to provide means, such as a user interface, for one or more digital artists to apply for participation in the development of the digital content. Typically, a model artist visiting the platform 120 may browse the pool and select to apply to create a model for one of these concepts.

The web based platform 120 is further configured to provide means, such as a user interface, for notifying the originator about the application of the one or more digital artists. The web based platform 120 is further configured to provide means, such as a user interface, for authorizing the originator to accept or dismiss the application of the one or more digital artists, that is, the author or the concept artist must vote to approve or disapprove of the model artist's application after evaluating their profile page on the database 110, via the platform 120. If the originator chooses to approve of the model artist, the model artist is sent the concept or text description for development thereof.

In some embodiments, the web based platform 120 is further configured to provide means, such as a user interface, for the originator to review work of the selected one or more digital artists at one or more stages of the development of the digital content. Specifically, the web based platform 120 is configured to provide means, such as a user interface, for the selected one or more digital artists to share samples of work-in-progress of the digital content with the originator. That is, the model artist show the work in progress to the concept artist at one stage (mid-development of the model) for review via screenshot sent through the platform 120. The web based platform 120 is further configured to provide means for the originator to provide feedback on the shared samples of work-in-progress of the digital content, to the selected one or more digital artists. That is, the concept artist provides one round of feedback and artistic critique, via the platform 120. The model artist, subsequently, proceeds to complete the model.

In some embodiments, the web based platform 120 is further configured to provide means, such as a user interface, for the originator to provide ratings to the profiles of the selected one or more digital artists based on the completed digital content. In one example, both users (concept artist and the model artist) of the platform 120 may rate the others collaboration interaction. If the model artist does not follow the concept artist's direction, the said model artist will receive a low rating from the concept artist which will lower his/her collaboration score. This score is shown on their profile page. The web based platform 120 is further configured to provide means, such as a user interface, for the originator to check ratings of the profiles of the one or more digital artists. For example, a low rating will impact future requests to collaborate with other artists. In one example, the database 110 is configured to rank the profiles of the plurality of digital artists based on the corresponding ratings.

The web based platform 120 is further configured to provide means, such as a user interface, for receiving recommendations, from the originator and the selected one or more digital artists, about a possible value of the completed digital content. The web based platform 120 is further configured to provide means, such as a processing device, for assigning a value to the digital content being listed for sale, based at least in part on the received recommendations. In one example, the platform 120 decides the final price based on an average of the suggested price by both the concept artist and the model artist.

At this point, the completed digital content (an untextured gray model) is first stored in a data repository (preferably, part of the database 110). The untextured gray model is, then, added to the e-commerce platform 130, for example a stock 3D model store for public sale. The e-commerce platform 130 is configured to provide means, such as a digital marketplace, for listing the completed digital content, from the data repository, for sale. The e-commerce platform 130 is further configured to provide means, such as a computing device, for assigning a predetermined share value to the originator and the selected one or more digital artists, based at least in part on their participation in the development of the digital content; and splitting a revenue from a sale of the digital content between the originator and the selected one or more digital artists based on their predetermined share value. In one example, the proceeds are split between the concept artist and the model artist, further and further between the e-commerce platform 130 based on varying royalty percentages.

In one embodiment, the one or more pieces of information about the concept of the digital content is a completed digital content. The term “concept of digital content” being used here varies with the stages of the completion of the digital content. The initial concept may be inputted by the originator, where the originator is likely one of the author or the concept artist. After first stage of completion of the digital content, i.e. when the model artist has developed the concept to create the untextured 3D model, this untextured 3D model may become the next concept, and the original originator (the author or the concept artist) along with the model artist (who worked on development of the untextured 3D model) now becomes the originator for the next stage, the next stage being developing the untextured 3D model into a textured 3D model.

Subsequently, the texture artist may apply to texture or paint the gray 3D model. Again, the artists up the production chain, in this example the author and the concept artist, vote the subsequent artist (the texture artist) onto the project. In this round, both the concept artist and model artist must unanimously vote the texture artist to work on the digital content. The texture artist then paints the texture and the model is re-uploaded to the stock model store online at the average suggested price of all three collaborators.

The present disclosure supports a collaborative approach for creating digital content by facilitating the participation of, and delegation of functions among, the design artists in the development of the digital content, over the computer network 100. The computer network 100 provides an environment for one or more design artists to collaborate. In some examples, the environment is configured so that multiple design artists can collaborate. In some examples, the computer network is an online environment. For example, an online environment, in some embodiments, includes that a user device 12 accesses a server 10 or another user device 12 over a network. In some embodiments, the environment provides for direct collaboration between users. According to some further embodiments, users interact with each other through the environments in real time, through messaging that is not necessarily received in real time, or the like. In alternative embodiments, the environment provides for indirect collaboration. For example, in some embodiments, a work is provided from someone who is not a user of the environment. In some embodiments, the environment is an offline environment accessible through a user device 12. For example, an offline environment, in some embodiments, includes a copy of a work on a user device 12 that can be updated by a server 10 upon or after the user device 12 becomes connected to the server 10.

In some embodiments, the digital content includes creative content, such as music, audio works, video works, audiovisual works, game works, photographs, textual works, graphical works, software, live works, inventions, designs, software, computer applications, trademarks, businesses, companies, and other endeavors amenable to collaborative effort by one or a plurality of persons, entities, communities, networks, computers and/or other devices, including without limitation, robots and AI devices. The term “collaboration” as used herein is a non-transient manifestation of collaborative creative effort by one or more individuals and one or more other individuals and/or computers or other devices programmed to collaborate with one or more persons, computers or other devices. The disclosure enables the collection and storage of media files for use in developing digital content. The disclosure further supports the management of a digital content creation project by generating reports of unfulfilled specs and verifying that all referenced media files are available.

It may be contemplated that the computer network system 100 provides a large scale web application with the rules described built into the user experience, involving a user registration system, a profile database on a secure server, and a dynamically generating webpage to display all of the information. The system 100 mediates all the phases of 3D model production between separate remote parties via the webpage. Further the system 100 store all of the 3D model files on a secure server and build a download and upload protocol within the website (the platform 120). The system 100 allows users to customize their profile pages, upload images of their artwork, and browse galleries of images. Further, the system 100 allows various artists to interact via the platform 120, i.e., send messages to users via email to facilitate expedited collaboration. In one example, the system 100 allows to create cron jobs to update images galleries for various collections of artwork. Further, the e-commerce platform 130 creates a front end ecommerce site to sell the generated assets on a digital marketplace.

The present disclosure includes at least two stages of production within the system 100, such as, concepting and modeling. However, adding many stages to the system 100 in a chain creates a robust production line via a virtual web portal (the platform 120). A basic user account system, profile page system, user communication system, galleries of images of both 2D drawing and 3D models, online storage and distribution of both 2D image files and 3D object files, and a pay system are all integrated, in the present system 100.

### INDUSTRIAL APPLICABILITY

The present disclosure provides the system 100 for online collaboration between the artists for development of digital content. In one example, the system 100 allows artists to create accounts, on the website, and then they would be able to collaborate with artists specializing in different discipline to create an asset that they could not create alone. They are then able to bring this 3D asset to market for digital sale. The present system 100 solves the problem of highly specialized digital artists not being able to perform entire lists of operations needed to create a high quality 3D art asset. The asset is developed in stages with value added by an assembly line of artists via the rules and tools provided by the system 100.

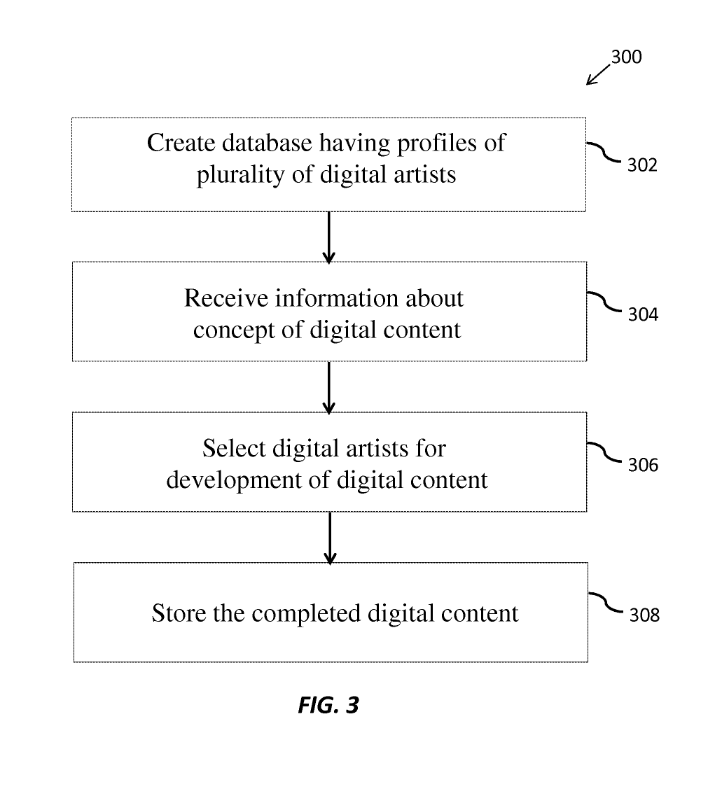

FIG. 3 illustrates the steps of a method 300 implemented, over the computer network 100, to facilitate online collaboration for developing a digital content. At step 302, the method 300 includes creating, via the computer network 100, a database 110 having profiles of a plurality of digital artists. At step 304, the method 300 also includes receiving, via the computer network 100, one or more pieces of information about a concept of the digital content. At step 306, the method 300 also includes selecting, via the computer network 100, one or more digital artists from the plurality of digital artists for participation in the development of the digital content from the concept. At step 308, the method 300 further includes storing, via the computer network 100, the completed digital content, after development, in a data repository.

The disclosed system 100 provides the process of creating online portals of collaborative assembly chains could apply to create 3D models, textured 3D models, rigged 3D models, and 3D animations, and further music production, animation production, video game production, film production or any digitally created medium where various skills are required and that can be managed remotely via a web portal system building in value in succession akin to a web based assembly line of artisans. The present disclosure provides an equivalent to an online factory system to create an assembly line for 3D model production. The system 100 allows artists of various skills; concept artists, 3D modelers, and 3D texture artists to build 3D models together for sale. The system 100 of the present disclosure provides advantage over the production houses by eliminating the expensive overhead and allows artists to self-regulate and act as freelancers.

The terms and descriptions used herein are set forth by way of illustration only and are not meant as limitations. Examples and limitations disclosed herein are intended to be not limiting in any manner, and modifications may be made without departing from the spirit of the present disclosure as defined in the appended claims. Those skilled in the art will recognize that many variations are possible within the spirit and scope of the invention as defined in the following claims, and their equivalents, in which all terms are to be understood in their broadest possible sense unless otherwise indicated.

We claim:

1. A computer network system implemented to facilitate online collaboration for developing a digital content, the system comprising:
a database configured to provide means for storing and retrieving profiles of a plurality of digital artists, and categorizing the profiles based on skills of the digital artists to provide at least one predefined service relating to developing the digital content; and
a web based platform configured to provide means for:
inputting one or more pieces of information about a concept of the digital content;
selecting one or more digital artists from the plurality of digital artists for participation in the development of the digital content from the concept; and
storing the completed digital content, after development, in a data repository.

2. The system of claim 1, wherein the one or more pieces of information about a concept of the digital content is inputted by an originator, the originator being one of the plurality of digital artists.

3. The system of claim 2, wherein the web based platform is further configured to provide means for controlling selection of the one or more digital artists for participation in the development of the digital content.

4. The system of claim 3, wherein the web based platform is further configured to provide means for:
one or more digital artists to apply for participation in the development of the digital content;
notifying the originator about the application of the one or more digital artists; and
authorizing the originator to accept or dismiss the application of the one or more digital artists.

5. The system of claim 2, wherein the web based platform is further configured to provide means for the originator to review work of the selected one or more digital artists at one or more stages of the development of the digital content.

6. The system of claim 5, wherein the web based platform is further configured to provide means for the selected one or more digital artists to share samples of work-in-progress of the digital content with the originator.

7. The system of claim 5, wherein the web based platform is further configured to provide means for the originator to provide feedback on the shared samples of work-in-progress of the digital content, to the selected one or more digital artists.

8. The system of claim 2, wherein the web based platform is further configured to provide means for the originator to provide ratings to the profiles of the selected one or more digital artists based on the completed digital content.

9. The system of claim 8, wherein the web based platform is further configured to provide means for the originator to check ratings of the profiles of the one or more digital artists.

10. The system of claim 8, wherein the database is configured to rank the profiles of the plurality of digital artists based on the corresponding ratings.

11. The system of claim 2, wherein the web based platform is further configured to provide means for:
receiving recommendations, from the originator and the selected one or more digital artists, about a possible value of the completed digital content; and
assigning a value to the digital content being listed for sale, based at least in part on the received recommendations.

12. The system of claim 2 further comprising, an e-commerce platform configured to provide means for listing the completed digital content, from the data repository, for sale.

13. The system of claim 12, wherein the e-commerce platform is further configured to provide means for:
assigning a predetermined share value to the originator and the selected one or more digital artists, based at least in part on their participation in the development of the digital content; and
splitting a revenue from a sale of the digital content between the originator and the selected one or more digital artists based on their predetermined share value.

14. The system of claim 2, wherein the digital content is a stock 3D model.

15. The system of claim 14, wherein the profiles of the plurality of digital artists are categorized as, an author, a concept artist, a model artist, a texture artist and a rigging artist.

16. The system of claim 15, wherein the originator is one of the digital artists with profile being categorized as either of the author, the concept artist, the model artist or the texture artist.

17. The system of claim 15, wherein the originator is a team of two or more digital artists with profiles being categorized as either of the author, the concept artist, the model artist or the texture artist.

18. The system of claim 17, wherein the one or more pieces of information about the concept of the digital content is a completed digital content.

19. A method implemented, over a computer network, to facilitate online collaboration for developing a digital content, the method comprising:
creating, via the computer network, a database having profiles of a plurality of digital artists;
receiving, via the computer network, one or more pieces of information about a concept of the digital content;
selecting, via the computer network, one or more digital artists from the plurality of digital artists for participation in the development of the digital content from the concept; and
storing, via the computer network, the completed digital content, after development, in a data repository.

20. The method of claim 19 further comprising, listing, via the computer network, the completed digital content, from the data repository, for sale.
